(19) United States
(12) Patent Application Publication
(10) Pub. No.: US 2022/0121097 A1
(43) Pub. Date: Apr. 21, 2022

(54) PROJECTION SCREEN AND PROJECTION SYSTEM

(71) Applicant: APPOTRONICS CORPORATION LIMITED, Shenzhen, Guangdong (CN)

(72) Inventors: Lin Wang, Shenzhen, Guangdong (CN); Wei Sun, Shenzhen, Guangdong (CN); Hongxiu Zhang, Shenzhen, Guangdong (CN); Fei Hu, Shenzhen, Guangdong (CN); Yi Li, Shenzhen, Guangdong (CN)

(21) Appl. No.: 17/309,533

(22) PCT Filed: Nov. 18, 2019
(86) PCT No.: PCT/CN2019/119133

§ 371 Date: Jun. 3, 2021

(30) Foreign Application Priority Data
Dec. 4, 2018 (CN) 201811472014.8

(51) Int. Cl. G03B 21/602; G03B 21/28; G02B 3/00

(52) U.S. Cl. CPC G03B 21/602; G02B 3/0006; G03B 21/28

(57) ABSTRACT

A projection screen and a projection system are provided. The projection screen includes a microlens array layer, a filter layer, and an optical structure layer arranged sequentially from an incident side of a projection light. The microlens array layer includes microlens units. The filter layer has a predetermined transmittance and is provided with a light-transmissive hole. The optical structure layer includes an optical microstructure unit capable of reflecting the incident light. The light-transmissive hole in the filter layer is arranged on the basis of an optical axis of the microlens unit in the microlens array layer so that the light-transmissive hole is exactly located on a focal plane of the microlens unit, and the projection light is reflected by the microlens unit, and then exactly passes through the light-transmissive hole. The projection screen has a high screen gain.

### TECHNICAL FIELD

The present disclosure relates to a projection screen and a projection system, in particular, to a projection screen that has an improved anti-ambient light property as well as a high gain and a projection system using the projection screen.

### BACKGROUND

At present, projection display systems have attracted wider attention. Especially in large-size home theater application scenarios, the advantages of the projection display systems are increasingly recognized by the public.

A screen is an important factor that affects a projection display system, and has great impact on image quality of projection display. Contrast of the screen is an important indicator for evaluating quality of the screen. Usually, a common projection screen can reflect light rays from both a projector and ambient light, so that contrast of an image reflected by the screen is much lower than that of the projector due to impact of the ambient light.

### SUMMARY

In view of the foregoing problem, the present disclosure aims to provide a projection screen with a simple structure, low costs, a high gain and high contrast, and a projection system.

An embodiment of the present disclosure discloses a projection screen, and the projection screen includes a microlens array layer, a filter layer and an optical structure layer that are sequentially arranged from an incident side of projection light. The microlens array layer includes microlens units. The filter layer has a preset light transmittance and is provided with light transmitting holes. The optical structure layer includes optical microstructure units that are capable of reflecting incident light. One of the light transmitting holes is formed exactly on a focal plane of one microlens unit of the microlens units, and the projection light exactly passes through the light transmitting hole after being refracted by the microlens unit.

Another embodiment of the present disclosure discloses a projection system, and the projection system includes the projection screen described above and a projector. In an embodiment, the projector is a short focus projector or an ultra-short focus projector.

As described above, in the projection screen and the projection system according to the present disclosure, a structure in which a microlens array and a filter layer with light transmitting holes are matched is used, thereby ensuring that the screen has a relatively high screen gain, and then anti-ambient light contrast of the screen is improved. In addition, the light transmitting holes of the present disclosure is provided on a surface of the filter layer and no additional light outlet is required, thereby reducing difficulty in a process of manufacturing the screen.

It should be understood that, beneficial effects of the present disclosure are not limited to the foregoing effects, but can be any beneficial effects described herein.

### BRIEF DESCRIPTION OF THE DRAWINGS

FIG. 1 is a schematic diagram of a laminated structure of a projection screen according to the present disclosure;

FIG. 2 is a schematic diagram of a planar structure of an optical structure layer of the projection screen according to the present disclosure;

FIG. 3 is a schematic diagram of an optical path principle of the projection screen according to the present disclosure;

FIG. 4 is a diagram of a relationship between a screen gain and reflectivity of the projection screen according to the present disclosure;

FIG. 5 is a schematic diagram of an optical path principle of a projection screen according to an embodiment of the present disclosure;

FIG. 6 is a schematic diagram of a projection screen according to a first embodiment of the present disclosure;

FIG. 7 is a schematic diagram of a microlens array layer of a projection screen according to a second embodiment of the present disclosure; and

FIG. 8 is a schematic diagram showing shapes and arrangements of light transmitting holes of a filter layer of the projection screen according to the second embodiment of the present disclosure.

### DETAILED DESCRIPTION

Specific embodiments according to the present disclosure are describes in detail below with reference to the accompanying drawings. It should be emphasized that all dimensions in the accompanying drawings are merely schematic and are not necessarily illustrated in true scale and are therefore not restrictive. For example, it should be understood that, a thickness, a thickness ratio and an angle of each layer in each layer structure in a projection screen are not shown in accordance with the actual dimension and scale, but merely for convenience of illustration.

To improve screen contrast in a situation where there is ambient light, many solutions have been proposed. For example, Patent document 1 (CN1670618A) discloses an anti-ambient light projection screen. Such a projection screen is a wire grid screen, and a microstructure unit thereof formed by an upper inclined plane and a lower inclined plane. A surface of the upper inclined plane is coated with a black light-absorbing material to absorb ambient light incident above the screen. A surface of the lower inclined plane is a base material made of white reflective resin to reflect light from a projector. However, a white diffuse reflection layer for reflection is not selective about an angle of incident light. Therefore, the ambient light incident to the white reflection surface can be reflected to a field of view of an audience, and a gain of the screen is generally less than 0.5. In addition, a wire grid structure can collimate only incident light in a central region of a cross section of the projector, causing gradual deterioration of a collimation effect from the middle of the screen to two sides of the screen. In addition, Patent document 2 (CN105408777A) proposes a screen with a circularly symmetrical Fresnel microstructure. Contrast of such a screen is improved by using different incident angles of projection light and ambient light. The ambient light is reflected by an upper reflective surface of a reflective layer to a ground direction. Therefore, this part of ambient light does not affect the contrast of the screen. However, in the solution of Patent document 2, another part of the ambient light is still reflected by a lower reflective surface of a reflective layer to a field of view of an audience. Therefore, the structure in Patent document 2 has a limited effect in improving contrast. In addition, there is also a screen structure using a principle of total reflection today. A totally reflective screen structure utilizes the characteristics of different incident angles of projection light and ambient light, so that the projection light incident at a large angle meets a total reflection condition and is reflected, while the ambient light incident at a small angle passes through a structure layer and is absorbed. However, due to the relatively harsh total reflection condition, such a structure can cause a part of the projection light that does not meet the total reflection condition to be wasted. As a result, light utilization of a screen with such a structure is not high. In addition, due to relatively large areas of two reflective surfaces of a totally reflective structure, ambient light from above the screen that is symmetrical to the projection light is reflected to a field of view of an audience. Therefore, an anti-ambient light property of the above screen is limited.

### 1. Overview of the Present Disclosure

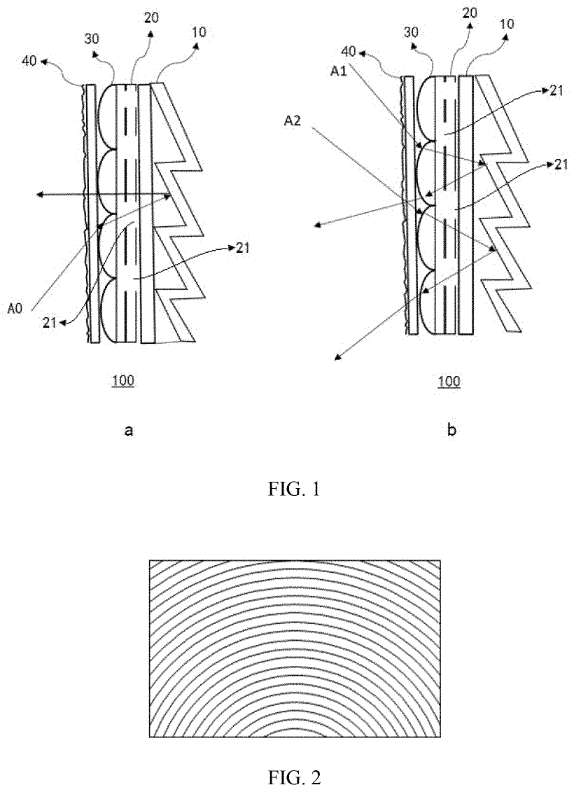

FIG. 1 is a schematic side view of a projection screen according to the present disclosure. As shown in FIG. 1, the projection screen 100 according to the present disclosure has a multi-layer laminated structure which includes an optical structure layer 10, a filter layer 20, a microlens array layer 30 and a diffusion layer 40 that are sequentially arranged from an inner side of the screen (that is, a side facing away from incident light) to an outer side of the screen (that is, a side facing towards the incident light). The optical structure layer 10 has optical microstructure units that can reflect incident light. As shown in FIG. 2, the optical microstructure unit of the optical structure layer 10 is arranged in a ring shape. For example, the optical microstructure unit is a Fresnel microlens unit coated with a reflective layer, or a totally reflective microstructure unit. The optical structure layer 10 has a light-reflecting property. The filter layer 20 is made of a material having a preset light transmittance. A surface of the filter layer 20 is provided with light transmitting holes 21, and the light transmitting hole 21 is formed exactly on a focal plane of a microlens unit of the microlens array layer 30. For example, the light transmittance can range from 25% to 65%. A lens array is arranged in the microlens array layer 30. A position of the light transmitting hole 21 in the filter layer 20 is arranged based on a position of an optical axis of the microlens unit of the microlens array, so that projection light from below the screen exactly passes through the light transmitting hole 21 in the filter layer 20 after being refracted by the microlens units. The diffusion layer 40 is configured to diffuse a collimated light beam from the microlens array layer 30, so that the projection screen 100 has a larger viewing angle.

As shown in FIG. 1a, projection light A0 from a short focus projector or an ultra-short focus projector located below the screen is refracted and focused by the microlens array layer 30, and then passes through the light transmitting hole 21 of the filter layer 20. A projection light beam transmitted through the light transmitting hole 21 of the filter layer 20 passes through the filter layer 20 after being reflected (for example, a specular reflection or a total reflection) by the optical structure layer 10, and finally enters a field of view of an audience through the diffusion layer 40. As shown in FIG. 1b, since incident directions and angles of ambient light A1 and ambient light A2 from above or obliquely in front of the screen are completely different from incident directions and angles of the projection light A0, respectively, an incidence position after refraction by the microlens array layer 30 does not match a position of the light transmitting hole 21 in the filter layer 20. Therefore, as shown in the figure, most of the ambient light is attenuated twice by the filter layer 20 from its incidence to its exit, and light intensity of the ambient light when exiting is much smaller than light intensity of the projection light A0 attenuated only once, thereby improving an anti-ambient light property of the screen. In addition, because the optical structure layer 10 has a high reflectivity, the projection screen 100 according to the present disclosure can also have a high screen gain. The projection screen 100 according to the present disclosure usually used in a short focus projector or an ultra-short focus projector, and the two together form a projection system with a high gain and a high contrast.

### 2. Discussion of the Principle of Improving Contrast

As described above, to improve the contrast of the screen, the projection screen 100 of the present disclosure adopts a technical solution in which the microlens array matches the light transmitting hole. Because the ambient light passes through the filter layer twice from its incidence to its exit, the ambient light can be effectively absorbed, and the anti-ambient light property of the screen can be improved. This aspect is described in detail below.

First, it is assumed that the light transmittance of the filter layer 20 is a, and the reflectivity of the optical structure layer 10 is b. A total reflectivity of the projection screen 100 to the projection light and a total reflectivity of the projection screen 100 to the ambient light according to the present disclosure, respectively, are:

r_{projection}=ab (1), and

r_{ambient}=a²b (2).

In this specification, black contrast of the screen is defined as a ratio of brightness of the ambient light shining on a Lambertian scatterer to brightness thereof on the screen. Because the ambient light comes from all directions, a surface of the screen is approximately considered as a Lambertian scattering surface. In this case, the following formula can be obtained.

$$p = \frac{{E}_{ambient} / π}{{r}_{ambient} {E}_{ambient} / π} = \frac{1}{{r}_{ambient}} = \frac{1}{{a}^{2} b} , \qquad ( 3 )$$

where ρ is the black contrast, and E_{ambient} is illuminance of the ambient light on the surface of the screen.

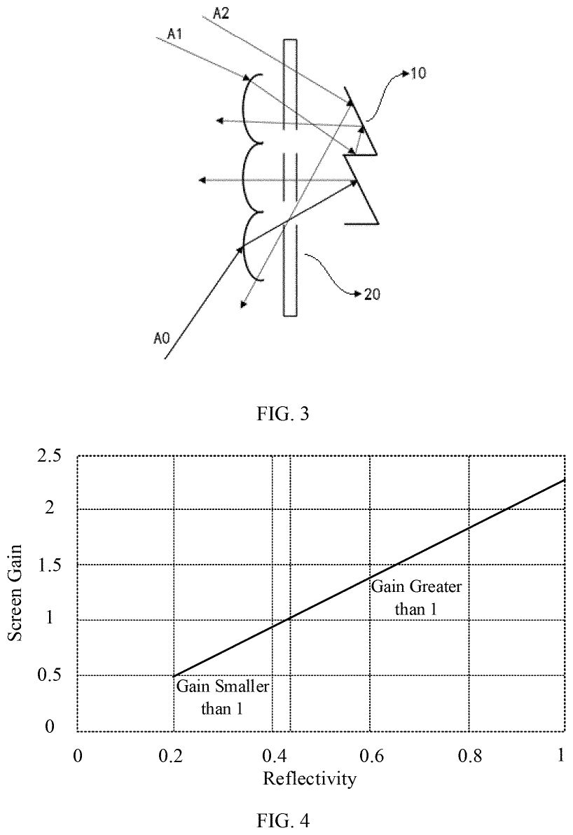

In this case, assuming that the light transmittance of the filter layer 20 is 50%, and the reflectivity of the optical structure layer 10 is 90%, the projection screen 100 has a reflectivity r_{projection} of 45% to the projection light and a reflectivity r_{ambient} of approximately 23% to the ambient light. It can be calculated with the foregoing formula (3) that the contrast of the projection screen 100 of the present disclosure is 4.3 in this case. Such a value is already higher than that of contrast of a common anti-ambient light screen on the market. In fact, as shown in FIG. 3, in a case in which the optical structure layer 10 adopts a structure having a Fresnel lens and a reflective layer, a part of the ambient light (for example, ambient light A1) is reflected twice by the optical structure layer 10 due to an incident angle. As a result, an actual reflectivity of this part of the ambient light is smaller than 23%. In addition, in a case in which the optical structure layer 10 adopts a totally reflective structure, most of the ambient light passes through the optical structure layer due to not meeting a total reflection condition. As a result, an actual reflectivity of this part of the ambient light is much smaller than 23%. Therefore, an actual contrast of the projection screen 100 according to the present disclosure is more desirable.

In addition, it is known that a viewing angle of a white Lambertian reflection is ±60 degrees, if the reflectivity is 100%, a screen effect with a gain of 1.0 can be achieved. If the reflectivity of the screen decreases, a gain of diffuse reflection also decreases. In a common projection viewing application, a viewing angle of ±20 degrees to ±30 degrees can already meet a general household viewing requirement. Therefore, a gain of a low-reflectivity screen can be increased to a level greater than 1.0 by reducing the viewing angle. Taking a viewing angle of ±22.5 degrees as an example, FIG. 4 shows a relationship between the reflectivity of the optical structure layer 10 and the screen gain when the light transmittance of the filter layer 20 is 50%. It can be learned from FIG. 4 that in this case, the reflectivity of the optical structure layer 10 of the projection screen 100 according to the present disclosure can range from 42% to 100%. A person skilled in the art can develop various products with different gains and fields of view according to design needs by adjusting different combinations of the reflectivity of the optical reflective layer 10 and the light transmittance of the filter layer 20.

### 3. Arrangement Principle of the Microlens Array Layer

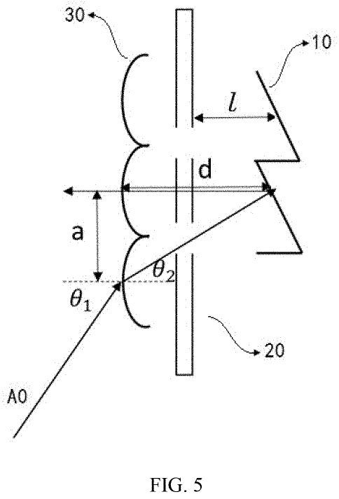

A position relationship between and an arrangement principle of the microlens array layer 30, and the optical structure layer 10 and the filter layer 20 are described in detail below with reference to FIG. 5.

As shown in FIG. 5, it is assumed that an incident angle of the projection light A0 of the projector is θ₁, an angle between the projection light A0 deflected by the microlens unit in the microlens array layer 30 and a horizontal direction (that is, a direction perpendicular to a screen plane) in the figure is θ₂, a distance between vertices of adjacent microlens units in the microlens array layer 30 is a, a curvature radius of the microlens unit is r, a focal length of the microlens unit is f, a horizontal distance between the microlens array layer 30 (that is, the microlens unit) and the optical structure layer 10 is d, a horizontal distance between the filter layer 20 and the optical structure layer 10 is l, n₂ is a refractive index of a material of the microlens array layer 30, and n₁ is a refractive index of a medium located on an outer side of the microlens array layer 30.

It can be learned from the principle of geometric optics that, the horizontal distance d between the microlens unit and the optical structure layer 10 can be expressed as follows:

$$d = \frac{a}{tan {θ}_{2}} . \qquad ( 4 )$$

In addition, it can be learned that the curvature radius r of the microlens unit can be expressed by the following formula:

$$r = \frac{{n}_{2} - {n}_{1}}{{n}_{2}} f , \qquad ( 5 )$$

where d=f+l.

Therefore,

$$r = \frac{{n}_{2} - {n}_{1}}{{n}_{2}} ( \frac{a}{tan {θ}_{2}} - 1 ) . \qquad ( 6 )$$

It can be learned from the foregoing formulas (4) to (6) that, the incident angle θ₂ of the projection light after being refracted by the microlens unit, the distance a between the vertices of adjacent microlens units, the focal length f of the microlens unit and the distance l between the filter layer 20 and the optical structure layer 10 jointly determine the curvature radius r of the microlens unit.

In actual application, because a short focus projector or an ultra-short focus projector is placed under the screen, the incident angle θ₂ of the projection light from the projector on the entire projection screen is different. Therefore, there are the following cases:

Case (1): when the distance a between the vertices of the microlens units of the microlens array layer 30 is fixed, the horizontal distance d between the microlens array layer 30 and the optical structure layer 10 changes. Therefore, the focal length f of the microlens unit changes accordingly, and the distance l between the filter layer 20 and the optical structure layer 10 also changes with the angle of refraction θ₂ of the projection light. As a result, the curvature radius r of the microlens unit changes.

Case (2): when the horizontal distance d between the microlens array layer 30 and the optical structure layer 10 is fixed, the distance a between the vertices of the microlens units changes, and the distance l between the filter layer 20 and the optical structure layer 10 also changes with the angle of refraction θ₂ of the projection light.

It can be learned through combination of the two cases that, in the microlens array layer 30 of the projection screen 100 according to the present disclosure, the curvature radius r of the microlens unit and/or the distance a between the vertices of the microlens units changes (for example, changing with a change of the angle of refraction θ₂ of the projection light), that is, microlens array is arranged non-periodically. Such a non-periodic microlens array structure also avoids diffraction or the moiré effect.

### 4. First Embodiment

The first embodiment of the projection screen according to the present disclosure is specifically described below.

As described above, the projection screen 100 according to the present disclosure includes the optical structure layer 10, the filter layer 20, the microlens array layer 30 and the diffusion layer 40 that are sequentially arranged from an inner side to an outer side of the projection screen 100.

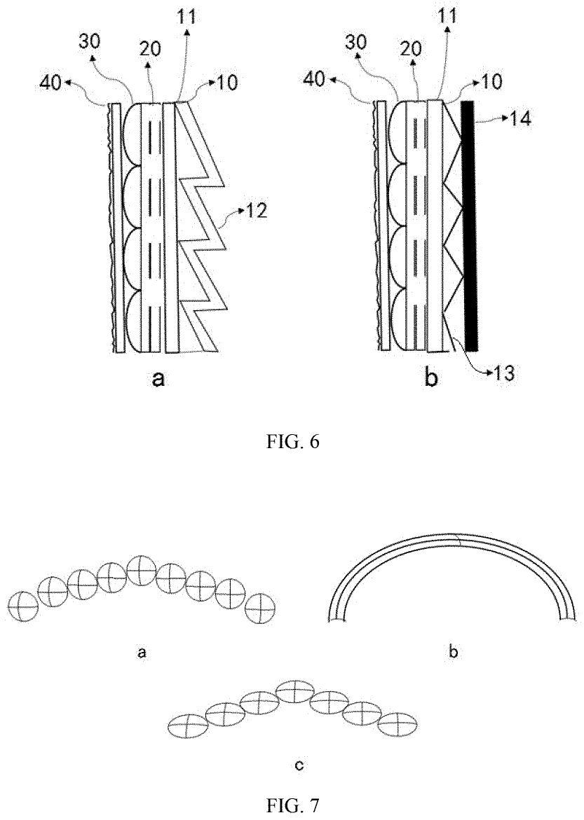

In the first embodiment, the optical structure layer 10 is formed on a transparent substrate through hot embossing or UV glue transfer. The transparent substrate includes organic materials, such as, PET, PC, PVC, and PMMA. The optical structure layer 10 can include a Fresnel microstructure coated with a reflective layer, which is shown in FIG. 6a; or can include a totally reflective microstructure, which is shown in FIG. 6b. If the Fresnel microstructure unit is used as an optical microstructure unit, the optical structure layer 10 includes, for example, a transparent substrate layer 11 and a Fresnel microstructure layer 12. The reflective material can be evenly coated on a surface of the Fresnel microstructure by spraying, screen printing, printing, or in other manners, and a thickness of the printing can be accurately controlled. Usually, in order that the reflective material on the surface of the microstructure does not change a tilt angle of the microstructure, the coating thickness generally should not exceed ⅕ of a pitch of the microstructure unit. For example, the reflective material can be made of a mixture of metal reflective materials such as aluminum flakes, aluminum powder or silver powder, and other additives. The additives include a particular proportion of mixture for increasing a coating effect (such as, a leveling agent, a wetting agent, a defoaming agent) and a particular proportion of mixture (such as, anhydrous acetone, anhydrous xylene, anhydrous cyclohexanone, anhydrous butanone, ethyl acetate and anhydrous butyl acetate that are used as solvents). If the optical microstructure unit is a totally reflective microstructure unit, in order to improve the contrast of the screen, a black light-absorbing layer is glued to the back of the total reflection microstructure. In other words, the optical structure layer 10 includes a substrate layer 11, a totally reflective microstructure layer 13 and a black light-absorbing layer 14. The totally reflective microstructure unit includes two totally reflective surfaces that form a preset angle. The projection light meets the total reflection condition, and total reflection occurs on both the totally reflective surfaces. The ambient light that does not meet the total reflection condition passes through the optical microstructure layer and is absorbed by the black light-absorbing layer behind. For example, the black light-absorbing layer can be formed by extrusion using a base material, or can be formed by spraying black ink on the transparent substrate. A black or gray base material can be made by doping black absorbing material particles into a transparent base material. For example, the black absorbing material can be an organic pigment (such as azo) or an inorganic pigment (such as carbon black, graphite, or metal oxide).

The microlens array layer 30 can be formed by the following methods: first coating a surface of the substrate with glue with a particular thickness, and then using structure transfer and being cured with UV light; or directly performing hot embossing on the surface of the substrate. The substrate can be made of an organic material with excellent light transmittance, such as PC, PET or PMMA. For example, the filter layer 20 can be formed on a back side of the substrate of the microlens array layer 30 (that is, a side opposite to a side on which the microlens array is formed). For example, a layer of a filter material preparation with a preset light transmittance is evenly coated on the back side of the substrate, and a light concentrating effect of the microlens array is utilized, to cure the filter material at a preset position and on the back side of the microlens array according to a principle of selective light curing. Specifically, to guide the projection light from the projector to the surface of the optical structure layer 10 as much as possible, a position of a curing light source of the coating should coincide with an actual use position of the projector as closely as possible. A shrunken light spot is formed after light emitted by the curing light source is focused by the microlens unit. Because a filter material preparation contains photosensitive glue, photosensitive glue in a region irradiated by the light spot undergoes a curing reaction, while photosensitive glue outside a range of the light spot does not undergo a curing reaction. The filter material that has undergone the curing reaction at the preset position is washed away, thereby forming the filter layer 20 with the light transmitting hole 21. The diffusion layer 40 can be a bulk diffusion film or a surface diffusion film, or be formed by frosting the surface of the microlens array.

As described above, the diffusion layer 40, the microlens array layer 30, the filter layer 20 and the optical structure layer 10 are bonded together through glue, to form the projection screen according to the first embodiment of the present disclosure with a high gain and a high contrast.

### 5. Second Embodiment

The second embodiment of the projection screen according to the present disclosure is described below with reference to FIG. 7. The second embodiment is a variant of the first embodiment, and a main difference lies in an arrangement manner of the microlens units of the microlens array layer 30 and the light transmitting holes 21 of the filter layer 20. Therefore, parts the same as those of the first embodiment are not repeated in the following description.

In the first embodiment, as shown in FIG. 7a, the microlens array in the microlens array layer 30 is a spherical microlens unit with a circular cross section. The projection light is focused by the spherical lens to form a circular light spot. Therefore, the light transmitting hole 21 of the filter layer 20 that corresponds to the microlens array can be a round hole. In this case, the light transmitting hole 21 occupies a smallest proportion of an area of the filter layer 20, so that more ambient light can be attenuated twice and a higher contrast can be obtained. However, such a spherical lens makes an exiting light beam compressed in both horizontal and vertical directions, resulting in a relatively small field of view. Therefore, in the second embodiment, a cylindrical lens that compresses a light beam in only the vertical direction and is shown in FIG. 7b can be used, to ensure a viewing angle of the screen in the horizontal direction. However, in this case, the light transmitting hole 21 fitting such a lens is a strip-shaped slotted opening, an opening area is increased, which decreases the contrast. If a compromise solution of the viewing angle and the contrast of the screen is considered, the microlens array of the microlens array layer 30 can be selected as an ellipsoidal lens with an oval cross section shown in FIG. 7c. A long axis of the ellipsoidal lens extends in the horizontal direction, a short axis thereof extends in the vertical direction, and a curvature radius r₂ in the long axis direction ranges from the curvature radius r₁ in the short axis direction to infinity. In a case where the microlens unit is the ellipsoidal lens, the contrast of the screen is improved compared with the case where the microlens unit is the cylindrical lens, and a horizontal viewing angle of the screen is improved compared with the case where the microlens unit is the spherical lens. It should be noted that, in order to match a ring-shaped arrangement of the optical structure layer 10 shown in FIG. 2, the microlens units in the microlens array layer 30 are arranged in a similar ring shape in all the foregoing three cases.

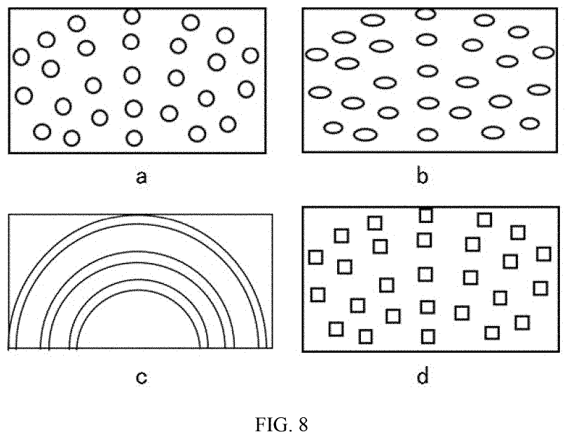

In addition, as described above, in the first embodiment, the filter layer 20 is made of a material having a preset light transmittance. For example, PET, PI, PC, PP, PMMA and other materials are used to make substrates, and dark particles such as carbon black and graphite are added. As shown in FIG. 8a, corresponding to a hemispherical microlens unit of the microlens array layer 30, the light transmitting hole 21 in the filter layer 20 is a round hole. However, in the second embodiment, in order to match the structure in the microlens array layer 30, the light transmitting holes 21 in the filter layer 20 are accordingly strip-shaped holes or oval holes arranged in a ring shape, which is shown in FIG. 8b and FIG. 8c. In addition, the light transmitting hole 21 in the filter layer 20 can be of another shape, such as a square (as shown in FIG. 8d) or a triangle. Provided that the light transmitting hole 21 can match the microlens unit of the microlens array layer, there is no particular limitation.

In an embodiment, on a screen plane of the projection screen, the microlens units of the microlens array layer are arranged in a ring shape, the light transmitting holes of the filter layer are arranged in a ring shape, and the optical microstructure units of the optical structure layer are arranged in a ring shape.

In an embodiment, each of the optical microstructure units of the optical structure layer is a Fresnel microlens unit coated with a reflective layer, and the optical structure layer includes a substrate layer and a Fresnel microstructure layer. The reflective layer is coated with a thickness, for example, not exceeding ⅕ of a pitch of one of the optical microstructure units. In an embodiment, each of the optical microstructure units of the optical structure layer is a totally reflective microstructure unit, and the optical structure layer includes a lens substrate layer, a totally reflective microstructure layer and a black light-absorbing layer.

In an embodiment, in an entity of the projection screen, at least one of a curvature radius of each of the microlens units of the microlens array layer or a distance between vertices of adjacent microlens units of the microlens units changes with a change of an angle of refraction of the projection light after the projection light is refracted by the microlens unit.

In an embodiment, the light transmittance of the filter layer ranges from 25% to 65%.

In an embodiment, reflectivity of the optical structure layer ranges from 42% to 100%.

In an embodiment, each of the microlens units is a spherical microlens unit, and each of the light transmitting holes is a round hole. In an embodiment, each of the microlens units is a cylindrical microlens unit, and each of the light transmitting holes is a strip-shaped slotted opening. In an embodiment, each of the microlens units is an ellipsoidal microlens unit, and each of the light transmitting holes is an oval hole.

In an embodiment, the projection screen further includes a diffusion layer located on an outer side of the microlens array layer.

Although the projection screen and the projection system according to the present disclosure have been described above with reference to the accompanying drawings, the present disclosure is not limited thereto. For example, in some cases, the projection screen according to the present disclosure can be provided with only the optical structure layer 10, the filter layer 20 and the microlens array layer 30, without the diffusion layer 40. In this case, the function of the diffusion layer 40 can be implemented by providing a scattering structure on the surface of the microlens array layer 30 or the optical structure layer 10. In addition, in the foregoing description, the optical microstructure unit is a Fresnel microlens unit coated with a reflective layer or a totally reflective microstructure unit. However, the type and structure of the optical microstructure unit is not limited thereto. Instead, all known optical microstructure units with suitable reflection characteristics can be used. Therefore, a person skilled in the art should understand that, various modifications, combinations, sub-combinations and variants can be made without departing from the essence or

1. A projection screen, comprising a microlens array layer, a filter layer and an optical structure layer that are sequentially arranged from an incident side of projection light, wherein the microlens array layer comprises microlens units, the filter layer has a preset light transmittance and is provided with light transmitting holes, and the optical structure layer comprises optical microstructure units that are capable of reflecting incident light; and one of the light transmitting holes is formed exactly on a focal plane of one microlens unit of the microlens units, and the projection light exactly passes through the light transmitting hole after being refracted by the microlens unit.

2. The projection screen according to claim 1, wherein on a screen plane of the projection screen, the microlens units of the microlens array layer are arranged in a ring shape, the light transmitting holes of the filter layer are arranged in a ring shape, and the optical microstructure units of the optical structure layer are arranged in a ring shape.

3. The projection screen according to claim 1, wherein each of the optical microstructure units of the optical structure layer is a Fresnel microlens unit coated with a reflective layer, and the optical structure layer comprises a substrate layer and a Fresnel microstructure layer.

4. The projection screen according to claim 3, wherein the reflective layer is coated with a thickness that does not exceed ⅕ of a pitch of one of the optical microstructure units.

5. The projection screen according to claim 1, wherein each of the optical microstructure units of the optical structure layer is a totally reflective microstructure unit, and the optical structure layer comprises a lens substrate layer, a totally reflective microstructure layer and a black light-absorbing layer.

6. The projection screen according to claim 1, wherein in an entity of the projection screen, at least one of a curvature radius of each of the microlens units of the microlens array layer or a distance between vertices of adjacent microlens units of the microlens units changes with a change of an angle of refraction of the projection light after the projection light is refracted by the microlens unit.

7. The projection screen according to claim 1, wherein the light transmittance of the filter layer ranges from 25% to 65%.

8. The projection screen according to claim 1, wherein reflectivity of the optical structure layer ranges from 42% to 100%.

9. The projection screen according to claim 1, wherein each of the microlens units is a spherical microlens unit, and each of the light transmitting holes is a round hole;
each of the microlens units is a cylindrical microlens unit, and each of the light transmitting holes is a strip-shaped slotted opening; or
each of the microlens units is an ellipsoidal microlens unit, and each of the light transmitting holes is an oval hole.

10. The projection screen according to claim 1, further comprising:
a diffusion layer located on an outer side of the microlens array layer.

11. A projection system, comprising a projector and a projection screen, wherein the projection screen comprises a microlens array layer, a filter layer and an optical structure layer that are sequentially arranged from an incident side of projection light, wherein the microlens array layer comprises microlens units, the filter layer has a preset light transmittance and is provided with light transmitting holes, and the optical structure layer comprises optical microstructure units that are capable of reflecting incident light; and one of the light transmitting holes is formed exactly on a focal plane of one microlens unit of the microlens units, and the projection light exactly passes through the light transmitting hole after being refracted by the microlens unit.

12. The projection system according to claim 11, wherein the projector is a short focus projector or an ultra-short focus projector.

13. The projection screen according to claim 1, each of the microlens units is a cylindrical microlens unit, and each of the light transmitting holes is a strip-shaped slotted opening.

14. The projection screen according to claim 1, wherein each of the microlens units is an ellipsoidal microlens unit, and each of the light transmitting holes is an oval hole.

15. The projection screen according to claim 1, wherein an incident direction and an angle of ambient light from above or obliquely in front of the projection screen are different from an incident direction and an angles of the projection light, respectively, an incidence position after being refracted by the microlens array layer does not match a position of the light transmitting hole in the filter layer, most of the ambient light is attenuated twice by the filter layer from its incidence to its exit, and light intensity of the ambient light when exiting is smaller than light intensity of the projection light attenuated only once.

16. The projection screen according to claim 6, wherein the curvature radius of one of the microlens units is determined based on an incident angle of the projection light after being refracted by the microlens unit, a focal length of the microlens unit, a distance between the filter layer and the optical structure layer, and the distance between the vertices of the adjacent microlens units.

17. The projection screen according to claim 10, wherein a scattering structure is provided on a surface of the microlens array layer or the optical structure layer.
